(19) United States
(12) Patent Application Publication
(10) Pub. No.: US 2023/0312228 A1
(43) Pub. Date: Oct. 5, 2023

(54) PORTION CAPSULE BASE BODY AND PORTION CAPSULE FOR A BEVERAGE PREPARATION MACHINE AND CORRESPONDING METHODS

(71) Applicant: Tchibo GmbH, Hamburg (DE)

(72) Inventors: Rüdiger Ternite, Hamburg (DE); Jens Bröckel, Hamburg (DE)

(21) Appl. No.: 18/041,820

(22) PCT Filed: Aug. 16, 2021
(86) PCT No.: PCT/EP2021/072695

§ 371 Date: Feb. 16, 2023

(30) Foreign Application Priority Data
Aug. 19, 2020 (EP) 20191803.4

(51) Int. Cl. B65D 85/804; B65D 65/46; A47J 31/36; A47J 31/06

(52) U.S. Cl. CPC B65D 85/8043; B65D 65/466; A47J 31/3633; A47J 31/3638; A47J 31/0668

(57) ABSTRACT

A portion capsule base body defines a directed axis and is fillable with an extraction material. The base body has a bottom region, a circumferential side wall adjoining the bottom region and having an outer surface, an a circumferential collar region adjoining the side wall, and through which an opening is defined. The axis is centrally extending through the bottom region and through the opening, and defines an axial direction pointing from the bottom region through the opening. A distance measured perpendicular to the axis is referred to as the axial distance, and the side wall has at least one ramp element by which at least one ramp region is defined in which the axial distance of the outer surface is increasing along the axial direction.

### BACKGROUND OF THE INVENTION

### Field of the Invention

The invention relates to the preparation of beverages or the like from an extraction material contained in a capsule (portion capsule), for example ground coffee. It relates to apparatuses and methods related to a portion capsule, to a portion capsule base body as well as to a combination of a portion capsule and a beverage preparation machine and also to a method for operating a beverage preparation machine as well as to a use of a portion capsule.

### Description of the Related Art

Beverage preparation machines for preparing beverages or the like from an extraction material present in a portion package are known, including but not limited to, as coffee or espresso machines. Due to the extraction process for the preparation of the beverage, they can also be referred to as extraction devices. In many corresponding systems, the portion packages are embodied as capsules (portion capsules), in which the extraction material is sealed, e.g., in an airtight manner. For the extraction, the capsule is pierced, for example on two opposite sides. An extraction liquid—usually hot water—is then introduced on the first side (injector side). On the second side (discharge side or extractor side), the extraction product is discharged from the capsule. This is done in a so-called brewing module. Such a module includes a brewing chamber in which the capsule is accommodated. Depending on the beverage to be prepared and on the system, quite considerable pressure must be present inside the capsule during the brewing process. As an alternative to systems in which the portion capsule is pierced, there are also systems with capsules that are already provided with a perforation which, for example, is covered by a protective film that is removed or dissolved before the brewing process.

Particularly popular are brewing modules in which the capsule is inserted and the brewing chamber is closed, for example, by means of an operating lever or by means of a motor, wherein when the brewing chamber is opened again after the brewing process, the capsule is automatically removed from the brewing chamber and ejected into a capsule container. Such brewing modules with automatic capsule ejection are usually designed as horizontal brewing modules, i.e. the capsule is inserted from above, the brewing chamber is closed by a horizontal relative movement of two brewing module parts (injector and discharge unit), the brewing liquid flows primarily horizontally, and the capsule container is embodied below the brewing chamber.

In case of brewing modules of this type, it has to be ensured that the inserted capsule is held until the brewing chamber is closed, but that it falls down when the brewing chamber is opened again after the brewing process.

WO 2015/048914 describes a brewing module including an extractor (discharge device; first brewing module part) and an injector (second brewing module part) which is movable relative thereto, wherein the extractor includes a head with mechanical control elements embodied as lateral guide means defining a first and a second path for a capsule collar, and wherein the extractor further forms a support limiting a downward movement of the capsule when the capsule collar is on the first path. Furthermore, the lateral guide means are connected to the head, and the injector includes a mechanical control element embodied as a retracting element adapted to engage and move the capsule collar into the second path upon opening the brewing chamber.

Aluminum and plastics, e.g. polypropylene, have become particularly well known as capsule materials. Aluminum capsules provide a very good shelf life (aroma protection) for the extraction material, but are very energy-intensive regarding their manufacture. Polypropylene capsules are advantageous regarding energy consumption and disposal, but place higher demands on the piercing mechanism and aroma protection. Both, aluminum and plastics, are criticized as capsule materials, the former in particular because of the high energy consumption during production, the latter especially because of the waste problem.

From WO 2010/118543, a coffee portion capsule is known, which is approximately cube-shaped, made of plastic and, unlike the known cup-shaped capsules, does not have a circumferential collar in the plane of the top cover surface. In other known capsule systems, such a circumferential collar is required, among other things, for closing the capsule by means of a foil serving as a lid. For sealing by ultrasonic welding, the collar is needed to accommodate an energy director. If the capsule is closed by thermal sealing, the collar is needed to ensure that the lid rests on a sufficiently large surface. In contrast thereto, according to the mentioned WO 2010/118543, a domed lid is used, and the sealing is accomplished, for example, by ultrasonic cutting and sealing. The capsule manufactured according to the teachings of WO 2010/118543 is composed of a capsule base body (with bottom region, side wall and collar region) and a lid, and thus has, irrespective of its (“cube”) shape, a circumferential welding brow arranged between the planes defined by the lower and upper lid surfaces, which forms only a minimal collar and whose extension/lateral protrusion is, however, significantly reduced compared to the collar of known capsules.

So-called bio-plastics have also been discussed as capsule materials. On the one hand, plastics that are made from a renewable raw material (so-called bio-based plastics) are referred to as such bio-plastics. On the other hand, bio-plastics can be plastics which are biodegradable (so-called biodegradable plastics). The plastics proposed for the production of portion capsules are biodegradable, and some include a share of bio-based plastics.

In this text, “biodegradable” means biodegradable according to the EN13432 standard (as of the end of 2019), and “bio-based” means “made from renewable raw materials, not fossil-based”.

The available bio-plastics, in particular biodegradable plastics, have the property that they already soften at relatively low temperatures and thus have a certain fluidity already at low temperatures (low glass transition temperature), but that they nevertheless have to be heated quite high until they are completely flowable (i.e. the melting temperature, as far as defined, is not particularly low). Softening already at relatively low temperatures entails a loss of mechanical stability of the capsule during the brewing process with a hot liquid. And if there is quite considerable pressure inside the capsule during the brewing process, the capsule must be designed in such a way that its mechanical stability is sufficiently large.

In WO 2017/017704, capsules made of biodegradable material are described that have reinforcing means to ensure mechanical stability of the capsule which allows an application of high internal pressures to the capsule. For example, filamentary material can be spirally applied to the outer surface of the side wall of the capsule.

Capsules with reinforcing means are also known from WO 2016/087981. There, profilings are provided at the side wall of the capsule which run parallel to the capsule axis.

Furthermore, most available bio-plastics, especially biodegradable plastics, have an modulus of elasticity at room temperature that is significantly greater than the modulus of elasticity of plastics conventionally used as capsule materials. For example, the modulus of elasticity of polypropylene typically ranges from 1000 Pa to 2000 Pa, while the modulus of elasticity of some bio-plastics exceeds 4000 Pa. Accordingly, identically shaped capsules made from such a bio-plastic exhibit a lower formability at room temperature than capsules made from polypropylene.

In addition, most available bio-plastics, especially biodegradable plastics, exhibit a greater brittleness at room temperature than plastics conventionally used as capsule materials.

Therefore, these properties must be taken into account when designing capsules made of bio-plastics.

### SUMMARY OF THE INVENTION

It is a possible object of the invention to provide a portion capsule and a portion capsule base body which can be made of plastics which are relatively brittle and/or have a relatively high modulus of elasticity; in particular wherein the portion capsule shall be usable in already existing beverage preparation machines.

Another possible object of the invention is to provide a portion capsule and a portion capsule base body which allow movements of the portion capsule in a brewing chamber of a beverage preparation machine for which a maximum force to be applied is relatively low.

Another possible object of the invention is to provide a portion capsule and portion capsule base body by means of which a user who manually generates movements of the portion capsule in the brewing chamber has a particularly smooth user experience and/or a user experience with little jerk.

Another possible object of the invention is to provide a portion capsule and a portion capsule base body by means of which movements of the portion capsule in the brewing chamber can be produced particularly smoothly and/or with little jerk, in particular by hand.

Another possible object of the invention is to provide a portion capsule and a portion capsule base body which make it possible to use a drive, for example an electric motor, which has a relatively low maximum force.

Another possible object of the invention is to provide a corresponding combination including a portion capsule and a beverage preparation machine.

Another possible object of the invention is to provide a corresponding method for operating a beverage preparation machine.

Another possible object of the invention is to provide a use of a portion capsule for reducing a maximum force to be applied for generating a relative movement of the portion capsule in a brewing chamber of a beverage preparation machine.

At least one of these objects is at least partially solved by apparatuses, methods and uses according to the patent claims.

To control movements of a portion capsule in a brewing chamber of a beverage preparation machine, it can be useful to move a mechanical control element, for example a mechanically preloaded lever arm, over the side wall of the portion capsule until an active region of the mechanical control element is moved over the projecting capsule collar. Such an action may take place, for example, in a beverage preparation machine as described in WO 2015/048914 mentioned at the beginning. For example, the mechanical control element can be a retracting element that allows the portion capsule to be retracted from a brewing position to an ejection position.

In order to be able to move the mechanical control element across the capsule collar, a greater force (maximum force) is usually required than for the movement of the active region of the mechanical control element along the side wall of the portion capsule base body prior thereto. A reduction of this maximum force makes possible to use a weaker or smaller-dimensioned motor and/or to reduce the amount of force that a user has to exert in case of manual operation.

Depending on the capsule material and/or design, when the active region of the mechanical control element is moved along the side wall of the portion capsule base body and/or when the active region of the mechanical control element is moved across the projecting capsule collar, the portion capsule can be deformed, due to the mechanical pretension of the mechanical control element, to a greater or lesser extent. This can reduce the required maximum force.

If the portion capsule is made of a material with a relatively high modulus of elasticity and thus deforms relatively little under the circumstances described, the maximum force required will be relatively high. Accordingly, a relatively strong motor would be necessary and a user would have to apply a greater force in the case of manual operation, respectively.

The inventors have recognized these interrelations and also found a solution therefor.

At least one ramp element is provided on the portion capsule, or more precisely on the portion capsule base body. Instead of—without ramp element—the mechanical control element having to be “suddenly” moved across by the full protrusion formed by the capsule collar, the mechanical control element can be pressed outwards by means of the ramp element beforehand already, so that when the capsule collar is reached, on the one hand the mechanical control element is already pressed far outwards and/or on the other hand the side wall of the portion capsule base body is already somewhat compressed. Both effects effect that the maximum force required for the movement (in particular when moving the active region of the mechanical control element across the capsule collar) is lower than would be the case without the ramp element.

In particular, the portion capsule base body can define a directed axis and can be fillable with an extraction material and can include:
a bottom region;
a circumferential side wall adjoining the bottom region and having an outer surface; and
a circumferential collar region adjoining the side wall and defining an opening;
   wherein the axis is centrally extending through the bottom region and through the opening and defines an axial direction pointing from the bottom region through the opening, and
   wherein a distance measured perpendicular to the axis is referred to as axial distance, the side wall including at least one ramp element defining at least one ramp region in which the axial distance of the outer surface along the axial direction is continuously or discontinuously increasing.

The axial distance can be continuously increasing. In other embodiments, the axial distance is discontinuously increasing.

The outer surface in the ramp region can form a sliding surface for a mechanical control element.

The ramp element can form a ramp to facilitate movement of a mechanical control element onto a capsule collar (of the filled and tightly sealed portion capsule) and across the same, or to reduce the maximum force required to do so.

The collar region can protrude outwardly (i.e., away from the axis) with respect to the side wall, at least where no ramp element is provided adjoining the collar region.

The ramp region can be tapered in a direction antiparallel to the axial direction.

In some embodiments, the at least one ramp region is located at a collar region sided end of the side wall. In particular, the at least one ramp region can be adjoining the collar region.

The ramp element can be located near the collar region. It can be adjoining the collar region, in particular it can be directly adjoining the collar region.

In some embodiments, the ramp element is circumferential.

In some other embodiments, the ramp element extends over only a portion of a periphery of the side wall. In such cases where the ramp element or ramp elements are each such a sectorial ramp element, circumferentially adjoining portions of the side wall can be free of ramp elements and can be otherwise configured, particularly if ramp elements would interfere there, for example by interfering with an interaction of other mechanical control elements with the portion capsule.

In some embodiments, the at least one ramp element, with respect to its axial extension (extension along the axis), is extended over only a portion of the side wall. In particular, it can be spaced from the bottom region.

In some embodiments, the side wall includes two side wall regions circumferentially adjoining the at least one ramp element, and the at least one ramp element (in particular for identical axial positions) protrudes outwardly relative to the two side wall regions, i.e. has a greater axial distance on the outside than the side wall regions. The at least one ramp element can be arranged circumferentially between the two side wall regions.

In the instant paper, “outward”/“outwardly” means as much as “in a direction along which the axial distance is increasing”.

In some embodiments, the side wall has two side wall regions circumferentially adjacent to the at least one ramp element in which the outer surface has a smaller axial distance than in the at least one ramp region.

In some embodiments, the collar region has an (outward) protrusion relative to the outer surface in the region of the at least one ramp element that is less than an (outward) protrusion that the collar region has in regions outside of the at least one ramp element, in particular that the collar region has in regions adjoining the at least one ramp element.

In some embodiments, the side wall includes at least a first and a second ramp element that are arranged opposite to one another with respect to the axis. In particular, the ramp region of the second ramp element can be identically formed to the ramp region of the first ramp element. For example, it can be provided that the ramp region of the second ramp element can be converted into the ramp region of the first ramp element by a rotation of 180° about the axis. And/or it can be provided that the ramp region of the second ramp element can be converted into the ramp region of the first ramp element by a reflection at a plane containing the axis. Such an arrangement and design (embodiment) of the ramp regions can also be provided for the ramp elements.

In some embodiments, the side wall includes at least two ramp elements, the ramp elements each being arranged in pairs opposite each other with respect to a plane containing the axis.

In some embodiments, the side wall includes at least two pairs of ramp elements, the first pair being mirror-invertedly arranged relative to the second pair with respect to a plane containing the axis. In particular, the ramp region of a first ramp element of the second pair can be identically configured to the ramp region of a first ramp element of the first pair, and the ramp region of a second ramp element of the second pair can be identically configured to the ramp region of a second ramp element of the first pair. In particular, the ramp elements of the pairs can be embodied such that the ramp regions of the ramp elements of the first pair can be converted into the ramp regions of the ramp elements of the second pair by a rotation of 180° about the axis. Such an arrangement and design (embodiment) of the ramp regions can also be provided for the ramp elements. It can be provided that all ramp regions of the pairs of ramp elements and, if necessary, also the ramp elements themselves are identically designed.

In some embodiments, the portion capsule base body includes at least four ramp elements, wherein the ramp regions, and optionally the ramp elements, are arranged and embodied in such a way that they can be converted into one another by a rotation of 90° about the axis. Such a fourfold symmetry can make possible to simplify the insertion of the capsule into a beverage preparation machine and into a brewing module, respectively, whereby a user does not have to pay attention or does not have to pay additional attention due to the ramp elements, to a specific orientation of the capsule during insertion. This may be particularly advantageous for portion capsule base bodies and portion capsules having an at least approximate fourfold symmetry, for example in the case of portion capsule base bodies or portion capsules having an approximately square footprint in a plane perpendicular to the axis. For example, apart from the at least one ramp element, the portion capsules can be formed as described above with respect to WO 2010/118543.

In some embodiments, for every direction perpendicular to the axis, the at least one ramp element is outwardly protruded by the collar region or protrudes outwardly maximally to the same extent as the collar region.

In some embodiments, for every direction perpendicular to the axis within the at least one ramp region, a maximum axial distance of the outer surface there in the ramp region is at most equal to a maximum axial distance there in the collar region.

In some embodiments, the capsule collar includes an (outward) protrusion relative to the outer surface in the range of the at least one ramp region that is zero and/or is less than an (outward) protrusion that the capsule collar has in ranges outside the at least one ramp element, in particular that the collar region has in ranges adjoining the at least one ramp element.

In some embodiments, the capsule collar has an (outward) protrusion relative to the outer surface in the range of the at least one ramp element that is zero and/or is less than one-half and, in particular, than one-third of an (outward) protrusion that the capsule collar has in ranges outside the at least one ramp element, in particular that the collar region has in ranges adjoining the at least one ramp element.

The opening can be a filling opening, in particular for filling-in extraction material, such as ground coffee.

The axis can also be referred to as central axis.

The continuous or discontinuous increase of the axial distance in the ramp region can refer in particular to an increase of the axial distance at one and the same direction perpendicular to the axis.

In the case of discontinuous increase, for example, a number of projections can be provided which are arranged consecutively with respect to the axial direction. Therein, it is possible to provide that respective maximum axial distances of the individual projections are the larger the closer the respective projection is to the collar region. Thus, several projections can be provided, each having a maximum axial distance, wherein these respective maximum axial distances increase in a direction parallel to the axial direction (from projection to projection). The protrusions can be embodied as beads. The protrusions can be spaced from each other along the axis. Alternatively, they can be contiguous.

In some embodiments, the portion capsule base body is made of a bio-plastic.

In some embodiments, the portion capsule base body is formed as a single piece.

In some embodiments, the at least one ramp element is manufactured in one and the same manufacturing process as the rest of the portion capsule base body. This enables an efficient and thus cost-effective production, while the alternative, i.e. the separate production of the ramp element and the rest of the portion capsule base body, is also possible but generally more costly.

In some embodiments, the portion capsule base body is fabricated by deep-drawing.

In some embodiments, the portion capsule base body is manufactured by injection molding. In addition to single-component injection molding, two—or more—component injection molding can also be considered, especially if the at least one ramp element is made of a different material than, for example, the rest of the portion capsule base body. The latter can be advantageous, for example, if the at least one ramp element shall have different mechanical properties than the rest of the portion capsule base body, for example in case the at least one ramp element shall be easier to deform.

The portion capsule can include a portion capsule base body of the type described herein, filled with an extraction material, and a lid sealingly connected to the portion capsule base body in the collar region, in particular wherein the lid is sealingly connected in an airtight manner.

In particular, the lid can be a domed lid, for example as described above for the aforementioned WO 2010/118543.

The portion capsule can have a capsule collar. In particular, for every direction perpendicular to the axis, the at least one ramp element can be outwardly protruded by the capsule collar or can or can protrude outwardly maximally to the same extent as the capsule collar.

For every direction perpendicular to the axis in the at least one ramp region, it can apply that a maximum axial distance of the outer surface in the ramp region there is at most equally large and in particular is equally large as a maximum axial distance of the capsule collar there.

The capsule collar can be circumferential.

At the capsule collar, the lid can be sealingly connected to the portion capsule base body.

The capsule collar can be provided between a top surface of the portion capsule (formed by the lid) and the bottom region (of the portion capsule base body); for example, as described above for WO 2010/118543.

In particular, the portion capsule can have the shape described above for WO 2010/118543—apart from the at least one ramp element.

In some embodiments, a projection of the capsule collar (perpendicular to the axis outside the ramp elements) amounts to between 0.5 mm and 2.5 mm, in particular between 0.8 mm and 2 mm, for example between 1 mm and 1.5 mm. This is, accordingly, the projection relative to the outer surface in areas without a ramp element.

The combination can include a portion capsule of the herein-described kind and a beverage preparation machine for receiving the portion capsule. In this regard, the beverage preparation machine can include a brewing chamber including an injector and a discharge unit.

The extraction unit can be provided for extracting an extraction product from a capsule.

The injector can be provided for introducing an extraction liquid into the portion capsule. The extraction liquid can be, for example, hot water.

The beverage preparation machine can be, for example, one as described above for WO 2010/118543. In particular, the brewing chamber can exhibit the features described above for WO 2010/118543.

In some embodiments, the brewing chamber includes at least one mechanical control element for controlling a movement of the portion capsule in the brewing chamber. It can be provided for cooperating with the at least one ramp element. In particular, the at least one mechanical control element can be provided for causing a movement of the portion capsule parallel to the axis or antiparallel to the axis, relative to the injector and/or to the discharge unit.

The mechanical control element can be a lever, for example.

The mechanical control element can be, for example, a retracting element by means of which the portion capsule can be pulled from a brewing position to an ejection position; for example, as described above for WO 2015/048914.

In particular, the mechanical control element can have a mechanical pretension, especially perpendicular to the axis, towards the axis.

In some embodiments, the brewing chamber is configured to hold the portion capsule in the brewing chamber, and the beverage preparation machine includes a drive for causing a relative movement of the held portion capsule parallel or antiparallel to the axis, relative to the injector and/or the discharge unit. And therein, the brewing chamber can be configured such that the at least one mechanical control element moves along on the at least one ramp region during the relative movement. The movement of the mechanical control element can be guided by the ramp element and in particular by the ramp region.

Moving the mechanical control element (in particular the active region of the mechanical control element) along on the ramp region can be, for example, a sliding along of the mechanical control element on the ramp region.

For example, two mechanical control elements arranged opposite to one another with respect to the axis can each cooperate with one of two ramp elements which are arranged opposite to one another with respect to a plane containing the axis.

The at least one mechanical control element (more precisely: the active region of the mechanical control element) can be pressed outwards (i.e. in a direction away from the axis) by the ramp element during and due to the movement on the ramp region.

The holding of the portion capsule can be realized, for example, by clamping, for example in another mechanical control element, or in that the portion capsule is guided by and supported against gravity by another mechanical control element. It can be realized, for example, as described above for WO 2015/048914.

The drive can be an electric drive, for example including an electric motor, and/or can be a manually operated drive.

In some embodiments, the mechanical control element has an active region, and the brewing chamber is configured in such a way that, during a relative movement caused by the drive, in which the mechanical control element moves parallel to the axis relative to the held portion capsule, the active region of the mechanical control element presses outwardly against the outer wall with a mechanical pretension and, in the course of the relative movement, moving along on the ramp region, is pressed increasingly further away from the axis, in particular continuously or discontinuously increasingly further away from the axis.

In this way, the axial distance of the active region can increase continuously or discontinuously—due to the interaction of the mechanical control element and the ramp element.

This allows an increasing mechanical tension of the mechanical control element to develop (with an inwardly pointing component, i.e. with a component towards the axis). This can reduce a force required to move the mechanical control element across the capsule collar—because by the mechanical control element, the side wall of the portion capsule is deformed, namely (slightly) depressed, so that it does not have to be pressed quite so far away from the axis against the mechanical tension.

Alternatively or additionally, the force required to move the mechanical control element across the capsule collar is reduced by the fact that the mechanical control element does not have to overcome a so large step. The mechanical control element needs to be pushed outwardly only a little bit to eventually overcome the capsule collar. This is because while moving along on the ramp element (more precisely: on the ramp region), the mechanical control element is already pressed outwardly (further and further).

During the moving along, there can be direct mechanical contact between the active region on the one hand and the outer wall and the ramp region of the ramp element, respectively, on the other hand.

It can be provided that in the further course of the relative movement, in particular after the moving along on the ramp region, the active region comes into contact with the capsule collar.

It can also be provided that the active region to move back towards the axis in the further course of the relative movement (in particular after the active region has come into contact with the capsule collar). This can cause the axial distance of the active region to decrease again. For example, the mechanical control element can then engage in an engagement position, for example in order to afterwards move the portion capsule towards the axial direction after a reversal of direction and, for example, to move it from a brewing position to an ejection position.

The method of operating a beverage preparation machine can include the following steps, wherein the beverage preparation machine includes a brewing chamber having at least one mechanical control element for controlling movements of a portion capsule in the brewing chamber, and wherein the mechanical control element includes an active region:
Optionally: inserting a portion capsule into the brewing chamber, the portion capsule having a side wall with at least one ramp element defining at least one ramp region, and the portion capsule defining an axis extending centrally through the portion capsule;
Holding the portion capsule in the brewing chamber;
generating a relative movement parallel to the axis between the at least one mechanical control element and the portion capsule, during which the active region presses against the side wall with a mechanical pretension on the outside and in the course of which
   the active region, while moving along on the outside of the ramp region, is pressed increasingly further away from the axis, in particular continuously or discontinuously increasingly further away from the axis; and/or
   the side wall is increasingly deformed by the mechanical control element, in particular is deformed inwardly.

For example, the portion capsule can be a portion capsule of the type described herein.

The deforming of the side wall can be an indenting of the side wall.

The deformation of the side wall can be caused, more precisely, by the active region.

The deformation of the side wall can take place in the ramp region.

Typically, both effects occur in the course of the relative movement: The active region is pushed outwardly, and the side wall is deformed by the mechanical control element; even if one of the effects occurs only to a very small extent. In an example, the distance by which the active region is pushed outwardly is much smaller than the distance by which the side wall is pushed inwardly, for example in the case of a very rigid mechanical control element and a relatively well-deformable side wall. In border cases, however, it may be that only one of the two effects occurs, i.e. for example the active region is not pressed outwardly, for example if the mechanical control element is extremely rigid and the side wall is very easily deformable.

The beverage preparation machine can be, for example, a beverage preparation machine as described above in WO 2010/118543.

Holding the portion capsule in the brewing chamber can be effected, for example, by at least one second mechanical control element.

For example, the at least one mechanical control element can be integrated in an injector of the brewing chamber and the at least one second mechanical control element can be integrated in a discharge unit of the brewing chamber. Alternatively, in other embodiments, the at least one mechanical control element can be integrated in an outlet unit of the brewing chamber and the at least one second mechanical control element can be integrated in an injector of the brewing chamber.

The relative movement can be effected by means of a drive, for example by means of a drive of the type described herein.

In some embodiments, the portion capsule includes a capsule collar, and in the further course of the relative movement, the active region comes into contact with the capsule collar. This can be the case after the moving along on the ramp region.

In some embodiments, in the still further course the relative movement, the active region moves back towards the axis. The axial distance of the active region then decreases accordingly.

Thereafter, in turn, in some embodiments, the at least one mechanical control element can engage in an engagement position.

A portion capsule of the type described herein can be used to reduce a maximum force to be applied (required) for a generation of a relative movement of the portion capsule in a brewing chamber of a beverage preparation machine.

As described already, the relative movement can be a movement of the portion capsule relative to a part of the brewing chamber, in particular relative to a mechanical control element of the brewing chamber, wherein the mechanical control element can be, for example, a mechanical control element of an injector of the brewing chamber—or alternatively, of a discharge unit of the brewing chamber.

The invention includes apparatuses with features corresponding to features of described methods or uses and, conversely, also includes methods and uses having features corresponding to features of described apparatuses.

Further embodiments and advantages are emerge from the dependent claims and the figures.

### BRIEF DESCRIPTION OF THE DRAWINGS

In the following, the subject matter of the invention is explained in more detail with reference to embodiment examples and the accompanying drawings. They show schematically:

FIG. 1 a portion capsule in a side view;

FIG. 2 the portion capsule base body of the portion capsule from FIG. 1, in perspective view;

FIG. 3A a section through a portion capsule base body just below the capsule collar, with two ramp elements arranged opposite each other with respect to the axis;

FIG. 3B a section through a portion capsule base body just below the capsule collar, with four ramp elements, two of which are arranged opposite each other with respect to the axis;

FIG. 4A a section through a portion capsule base body just below the capsule collar, with two pairs of ramp elements arranged mirror invertedly to each other;

FIG. 4B a sectional view of a portion capsule base body just below the capsule collar, with four pairs of ramp elements, two of which are mirror invertedly arranged with respect to each other and also the other two are mirror invertedly arranged with respect to each other, and wherein the ramp elements of each of the pairs are mirror invertedly arranged with respect to each other;

FIGS. 5A-5J strongly schematized sections, each through one half of a portion capsule base body;

FIGS. 6A-6C strongly schematized illustrations of a relative movement of a mechanical control element and a portion capsule with a ramp element, in a section;

FIGS. 7A-7C strongly schematic illustrations of relative movement of a mechanical control element and a portion capsule that does not include a ramp element, in a section;

FIG. 8 a strongly schematized illustration of a brewing chamber with inserted portion capsule with a ramp element.

### DETAILED DESCRIPTION OF THE INVENTION

Parts not essential for understanding the invention are, in part, not shown. The described embodiments are examples of the subject matter of the invention or serve to explain it, and have no limiting effect.

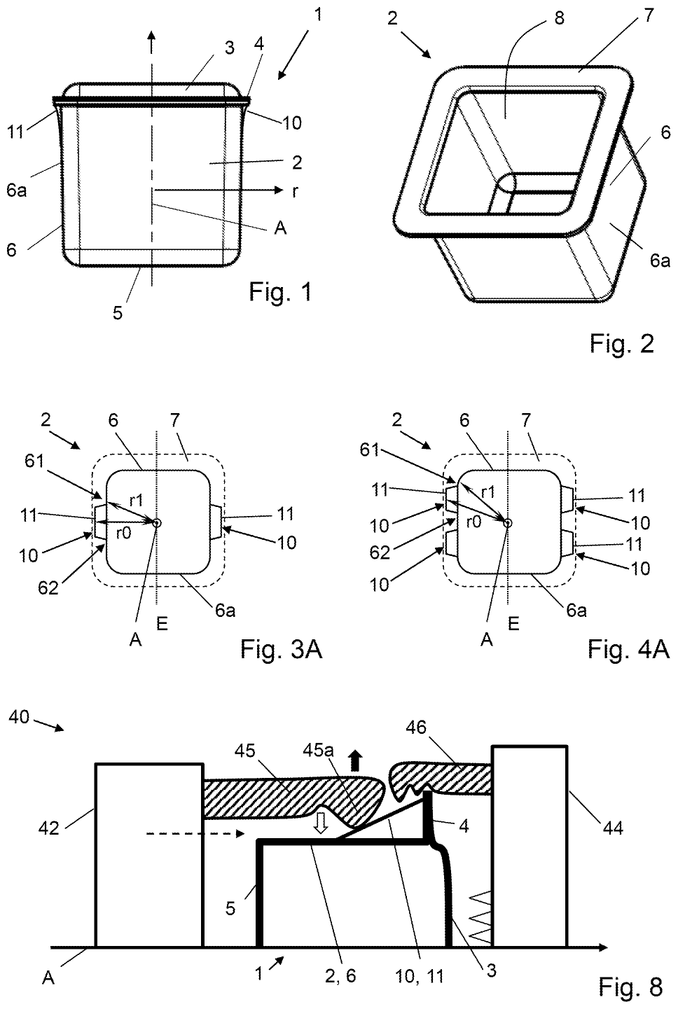

FIG. 1 shows a portion capsule 1 in a side view. The portion capsule 1 includes a portion capsule base body 2 and an outwardly curved lid 3, which are sealingly connected to one another in the region of a circumferential, outwardly projecting capsule collar 4.

FIG. 2 shows the portion capsule base body 2 of the portion capsule 1 of FIG. 1 in perspective view.

The portion capsule 1 is approximately cube-shaped and has a central axis A which is directed from a bottom region 5 towards the lid 3. Distances perpendicular to the axis A are referred to as axial distance r.

The bottom region 5 is connected to a circumferential side wall 6, the outer surface of which is marked 6a.

The portion capsule base body 2 has an opening 8 which, for example, can be used for filling the portion capsule base body 2, for example with ground coffee. The opening 8 is bounded by a collar region 7 of the portion capsule base body 2, which can project further than the capsule collar 4 of the portion capsule 1.

Further, the portion capsule base body 2 includes two ramp elements 10, which are not visible in FIG. 2, and each has a ramp region 11.

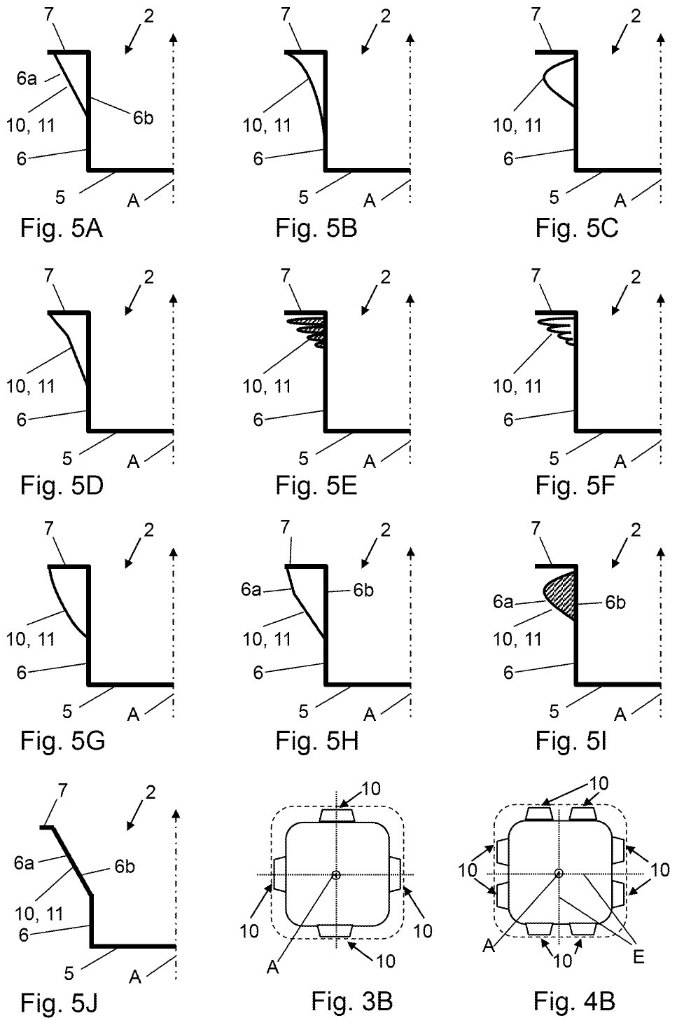

FIGS. 3A, 3B, 4A, 4B each show a section through a portion capsule base body 2 (or, equally, through a corresponding portion capsule 1) just below the collar region 7 (or the capsule collar 4—not explicitly labelled). Various exemplary arrangements of ramp elements 10 are shown. The ramp elements are sectorial ramp elements; each of them extends over only part of the circumference of the side wall.

The collar region 7 (or, equally, the capsule collar 4—not explicitly labelled) is shown dashed.

In the shown sectional plane just below the collar region 7 and the capsule collar 4, respectively, the ramp elements 10 are (sideways; outwardly) protruded by the collar region 7 as well as by the capsule collar 4.

Alternatively to the illustrated trapezoidal cross-section, the ramp elements 10 can also exhibit other cross-sections, for example rectangular or rounded.

Circumferentially on both sides of each ramp element 10, the side wall 6 includes side wall regions 61, 62 which adjoin the respective ramp element and in which the outer surface 6 has a smaller axial distance r1 than has the outer surface in the ramp region 11 (axial distance r0). And/or the collar region 7 as well as the capsule collar 4 protrude (laterally; outwardly) beyond the side wall 6 in the ramp region 11 less than in the side wall regions 61, 62.

As illustrated, there is an option for all ramp elements to be identically designed.

FIG. 3A illustrates the case of two ramp elements 10 arranged opposite each other with respect to the axis A. FIG. 3A can, for example, be a section through the portion capsule 1 and through the portion capsule base body 2, respectively, of FIGS. 1 and 2.

In FIG. 4A, two pairs of ramp elements 10 are provided, mirror-invertedly arranged with respect to one another, with respect to a plane E (dashed) containing axis A.

In FIGS. 3A and 4A, the ramp elements 10 are mirror invertedly arranged with respect to the plane E.

When pressure forces are applied to the ramp elements 10, it can be advantageous if they cancel each other out. Embodiments such as those shown in FIGS. 3A, 4A or also 3B, 4B are well suited for this purpose.

In FIG. 3B, the portion capsule base body 2 and the portion capsule 1, respectively, includes two pairs of ramp elements 10 arranged mirror invertedly with respect to each other, with respect to planes E (dashed) containing the axis A.

In FIG. 4B, the portion capsule base body 2 and portion capsule 1, respectively, includes four pairs of ramp elements 10, two of which are mirror-invertedly arranged with respect to each other (planes E), and also the other two are mirror invertedly arranged with respect to each other (planes E), and the ramp elements 10 of each of the pairs are mirror-invertedly arranged with respect to each other (planes E).

FIGS. 3B and 4B are examples of the fact that—in general—the ramp elements 10 can be arranged in such a way that they are converted into each other by a 90° rotation about the axis A. This can, in the illustrated case of a portion capsule 1 having an approximately square cross-section (perpendicular to axis A), simplify insertion of the portion capsule 1 (into a beverage preparation machine) because then no additional attention needs to be paid to the orientation of the portion capsule 1 during the insertion because of the ramp elements 10, as compared to the case where no ramp element 10 would be provided.

FIGS. 5A to 5J represent strongly schematized sections, in each case through one half of a portion capsule base body 2, the section plane passing through the ramp region 11 of a ramp element 10. Likewise, FIGS. 5A to 5J are to be understood as sections through a portion capsule 1, wherein in that case the collar region 7 would be considered as the capsule collar 4 and the lid 3 is not shown in the corresponding figure.

The ramp region 11 can be (completely) straight, as exemplarily shown in FIG. 5A and FIG. 5J.

The ramp region 11 can be concave in shape, as exemplified in FIG. 5B and also shown in FIG. 5D.

The ramp region 11 can be embodied as a bead, in particular a rounded bead; as exemplified in FIG. 5C.

The ramp region 11 can have multiple steps, as exemplified in FIGS. 5D, 5E, 5F and 5H. Therein, the individual steps can be straight each, as shown for example in FIGS. 5D, 5H, or curved (for example: FIGS. 5E, 5F).

The ramp region 11 can be convex in shape, as exemplified in FIGS. 5C, 5G, 5H and also in FIG. 5I.

The outer surface 6a in the ramp region 11 can have an axial distance r that is continuously increasing (parallel to the axis A), as exemplarily illustrated in FIGS. 5A, 5B, 5D, 5G, 5H, 5J.

The outer surface 6a in ramp region 11 can have an axial distance r which is discontinuously increasing, as exemplarily illustrated in FIGS. 5E, 5F.

The ramp element 10 can extend directly to the capsule collar 4 and to the collar region 7, respectively, as exemplified in FIGS. 5B, 5D, 5G, 5H, 5J.

The ramp element 10, in particular the ramp region 11, can exhibit a maximum axial distance r which is the same as the maximum axial distance there of the collar region 7 and of the capsule collar 4, respectively, as exemplified in FIGS. 5B, 5D, 5F, 5G, 5H.

The ramp element 10, in particular the ramp region 11, can exhibit a maximum axial distance r that is smaller than the maximum axial distance there of the collar region 7 and the capsule collar 4, respectively, as exemplified in FIGS. 5A, 5C, 5E, 5F, 5I, 5J.

The ramp element 10, in particular the ramp region 11, can have a distance from the capsule collar 4 or the collar region 7, as exemplarily shown in FIGS. 5C, 5E, 5F, 5I. This (axial) distance can be, for example, less than 20%, in particular less than 10% of the axial extension of the side wall 6, in particular of the ramp region 10, as exemplarily shown in FIGS. 5C, 5E, 5F, 5I.

The ramp element 10 may extend over only a portion of the axial extent of the side wall 6, as exemplified in FIGS. 5A through 5J.

The portion capsule base body 2 can have, in the region of the ramp element 10, an inner side wall part, as exemplarly shown in FIGS. 5A, 5B, 5C, 5D, 5F, 5G, 5H. In these cases, in the region of the ramp element 10, an inner surface 6b of the side wall is not formed by the ramp element 10, but by said side wall part.

In the range of the ramp element 10, both the outer surface 6a and the inner surface 6b of the side wall 6 can be formed by the ramp element 10, as exemplarily shown in FIGS. 5E, 5I, 5J.

The portion capsule base body 2 can be thickened in the region of the ramp element 10, as exemplarily shown in FIGS. 5E and 5I.

The portion capsule base body 2 can have the same sidewall thickness in the region of the ramp element 10 as in adjoining side wall regions, as exemplarily shown in FIG. 5J.

The ramp element 10 can be formed by the same material as other parts of the portion capsule base body 2, in particular as the remainder of the portion capsule base body 2. This may apply, as an option, to any of the described embodiments.

The ramp element 10 can be formed by a different material than other portions of the portion capsule base body 2 (for example, than the remainder of the portion capsule base body 2). This can apply, as an option, to any of the described embodiments.

For example, the material from which the ramp element 10 is formed can be a more easily deformable material, and in particular the material can be resilient. Such embodiments can be particularly advantageous for embodiments in which the axial distance r of the outer surface 6a is discontinuously increasing along the axial direction, such as in FIGS. 5E, 5F.

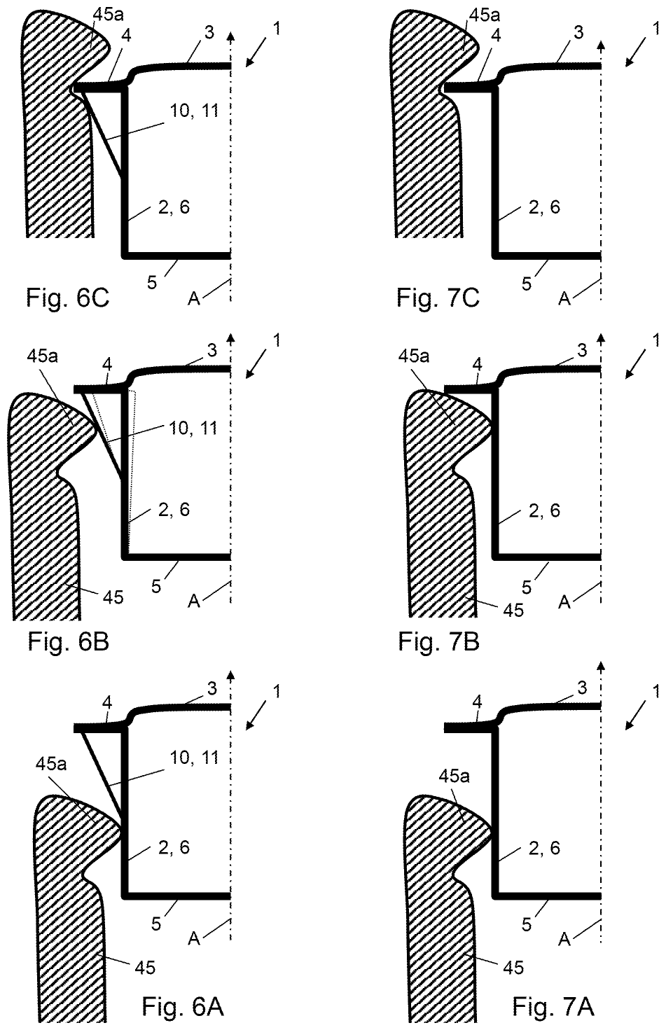

FIGS. 6A-6C show strongly schematic illustrations of a relative movement of a mechanical control element 45 with an active region 45a and a portion capsule 1 with a ramp element 10, in a section.

Analogously, FIGS. 7A-7C show such a movement for the case that the portion capsule 1 does not have a ramp element 10.

In FIGS. 6A to 6C and 7A to 7C a portion capsule 1 is illustrated which includes a portion capsule base body 2 corresponding to the one of FIG. 5A. A differently designed portion capsule base body 2 can be used as well, for example, one of those shown in FIGS. 5B to 5J or others herein described.

In the course of the relative movement, in the example shown, the active region 45a is moved, regarding to its axial position, from one side of the capsule collar 4 (base body side) to the other side of the capsule collar 4 (lid side)—i.e. parallel to axis A (and not antiparallel to axis A).

FIGS. 6A, 7A show an initial position. The active region 45a of the mechanical control element 45 presses, with a mechanical pretension, outwardly against the side wall 6—in an (axial) region without ramp element 10.

In FIG. 6B, the active region 45a is in direct mechanical contact with the ramp region 11. At least one of two effects results. On the one hand, the active region 45a is pressed further outward than in the case without ramp element (FIG. 7B). And on the other hand, the side wall 6 is indented (deformed inwardly) by the mechanical control element 45, or more precisely by the active region 45a. In FIG. 6B, it is indicated with dotted lines that the side wall 6—at least in the area of the ramp region 11—is deformed due to the inwardly directed force that the mechanical control element 45 exerts on the portion capsule 1 (more precisely: on the side wall 6).

In the further course of the relative movement, the active region 45a jumps over the capsule collar 45 in both cases, but in the case without a ramp element (FIGS. 7A to 7C), a relatively high force must be applied within a relatively short axial distance in order to press the active region 45a of the mechanical control element 45, over this distance, as far outward as is necessary. This requires application of a large force by the drive, be it an electric motor, or be it a manually operated drive. With a ramp element 10, on the other hand (FIGS. 6A to 6C), the maximum force required is significantly lower, because already while moving along on the ramp region 11, the active region 45a is pressed further and further outward and/or the side wall 6 is indented further and further, so that no such high force needs to be applied anymore to overcome the capsule collar 4.

Thus, by providing the ramp element 10, a reduction of the maximum force to be applied for performing the relative movement can be effected.

FIGS. 6C, 7C show a final state of the relative movement, which is after the capsule collar 4 has been overcome, and in which the axial distance r of the active region 45a has already been reduced again; also the deformation of the side wall 6 can now be smaller again or, as the case may be, be completely suspended. In this position, the mechanical control element 45 is engaged on the capsule collar. Due to the shape of the active region 45a, namely due to having a surface which points in a direction with a component antiparallel to the axial direction, the portion capsule 1 can be—after a reversal of direction (relative to the previously described relative movement)—retracted (in a direction antiparallel to the axial direction) by means of the mechanical control element 45, more precisely: by means of the surface, by means of which the active region 45 can act as a retraction hook.

FIG. 8 shows a strongly schematized representation of a brewing chamber 8 with inserted portion capsule 1 with ramp element 10. The brewing chamber has an injector 42 and a discharge unit 44. Connected to the injector 42 is a mechanical control element 45, which can be identical to the one described above. Connected to the discharge unit 44 is a second mechanical control element 46, by which the portion capsule 1 is held. The situation depicted in FIG. 8 can correspond to the status depicted in FIG. 6B, wherein here, there is no deformation of the side wall 6, or at least no such deformation is depicted in FIG. 8.

The dashed arrow symbolizes that the injector 42 moves together with the mechanical control element 45 parallel to the axial direction, relative to the portion capsule 1 (and to the discharge unit 44).

The open arrow symbolizes that forces pointing inwardly are exerted by the mechanical control element 45 on the outer surface 6a of the portion capsule 1, in particular on the ramp region.

The filled arrow symbolizes that the active region 45a is optionally pressed outwardly due to the relative movement and because of the ramp element 10.

As will be clear from the above, providing the ramp elements 10 described above, particularly when using an electrically powered motor and drive, respectively, to control the movements in the brewing unit 40, can allow a user to save energy and/or use a drive that is limited to producing smaller maximum forces than would be required for the same brewing unit with the same capsule but without a ramp element. And when the movements in the brewing chamber are manually driven, a user can operate the beverage preparation machine with less effort and/or a user has a more pleasant user experience, for example, because it is less jerky and/or feels smoother when performing the movement.

1. A portion capsule base body defining a directed axis and being fillable with an extraction material, comprising:
a bottom region;
a circumferential side wall adjoining the bottom region and having an outer surface; and
a circumferential collar region adjoining the side wall and defining an opening;
the axis extending centrally through the bottom region and through the opening and defining an axial direction pointing from the bottom region through the opening, and wherein a distance measured perpendicular to the axis is referred to as axial distance, the side wall comprising at least one ramp element defining at least one ramp region in which the axial distance of the outer surface increases along the axial direction.

2. The portion capsule base body according to claim 1, wherein the at least one ramp region is arranged at a collar region sided end of the side wall, in particular wherein the at least one ramp region is adjoining the collar region.

3. The portion capsule base body according to claim 1, wherein the at least one ramp element extends only over a part of a periphery of the side wall.

4. The portion capsule base body according to claim 1, wherein the side wall comprises two side wall regions peripherally adjoining the at least one ramp element, and wherein the at least one ramp element protrudes outwardly relative to the two side wall regions.

5. The portion capsule base body according to claim 1, wherein the side wall has at least a first and a second ramp element which are arranged opposite one another with respect to the axis, in particular wherein the ramp region of the second ramp element is designed identically to the ramp region of the first ramp element.

6. The portion capsule base body according to claim 1, wherein the side wall comprises at least two pairs of ramp elements, the first pair being arranged mirror-invertedly relative to the second pair with respect to a plane containing the axis, in particular wherein the ramp region of a first ramp element of the first pair is identically formed as the ramp region of a first ramp element of the second pair, and the ramp region of a second ramp element of the second pair is identically formed as the ramp region of a second ramp element of the first pair.

7. The portion capsule base body according to claim 1, wherein for every direction perpendicular to the axis the at least one ramp element is outwardly protruded by the collar region or protrudes outwardly maximally to the same extent as the collar region.

8. A portion capsule comprising the portion capsule base body filled with an extraction material according to claim 1 as well as a lid sealingly connected to the portion capsule base body in the collar region.

9. The portion capsule according to claim 8, comprising a capsule collar, wherein, for every direction perpendicular to the axis, the at least one ramp element is outwardly protruded by the capsule collar or protrudes outwardly maximally to the same extent as the capsule collar.

10. A combination comprising a portion capsule according to claim 8 and a beverage preparation machine for receiving the portion capsule, wherein the beverage preparation machine comprises a brewing chamber with an injector and a discharge unit.

11. The combination according to claim 10, wherein said brewing chamber comprises at least one mechanical control element for controlling a movement of said portion capsule in the brewing chamber, which is provided for cooperating with the at least one ramp element, in particular wherein the at least one mechanical control element is provided for causing a movement of said portion capsule parallel to said axis or antiparallel to said axis relative to the injector and/or to the discharge unit.

12. The combination according to claim 11, wherein the brewing chamber is adapted to hold the portion capsule in the brewing chamber and comprises a drive for effecting a relative movement of the held portion capsule parallel or antiparallel to the axis, relative to the injector and/or relative to the discharge unit, and wherein the brewing chamber is configured such that the at least one mechanical control element moves along the at least one ramp region during the relative movement.

13. The combination according to claim 12, wherein the mechanical control element comprises an active region and the brewing chamber is configured such that during a relative movement caused by the drive, during which the mechanical control element moves relative to the held portion capsule parallel to the axis, the active region of the mechanical control element presses, with a mechanical pretension, outwardly against the outer wall and, in the course of the relative movement, while moving along the ramp region, is pressed increasingly further away from the axis.

14. A method of operating a beverage preparation machine comprising a brewing chamber with at least one mechanical control element for controlling movements of a portion capsule in the brewing chamber, the mechanical control element comprising an active region, the method comprising the steps of:
inserting a portion capsule into the brewing chamber, the portion capsule comprising a side wall with at least one ramp element defining at least one ramp region, and the portion capsule defining an axis extending centrally through the portion capsule;
holding the portion capsule in the brewing chamber;
generating a relative movement parallel to the axis between the at least one mechanical control element and the portion capsule during which the active region presses with a mechanical pretension externally against the side wall and in the course of which:
the active region, while moving along on the outside of the ramp region, is pressed increasingly further away from the axis; and/or
the side wall is increasingly deformed by the mechanical control element;
and wherein the portion capsule is a portion capsule according to claim 1.

15. The method according to claim 14, wherein the portion capsule comprises a capsule collar, and wherein in the further course of the relative movement, the active region comes into contact with the capsule collar.

16. The method according to claim 15, wherein during relative movement the active region moves towards the axis again.

17. Use of a portion capsule according to claim 8 for reducing a maximum force to be applied for a generation of a relative movement of the portion capsule in a brewing chamber of a beverage preparation machine.
